(19) United States
(12) Patent Application Publication
(10) Pub. No.: US 2003/0115352 A1
(43) Pub. Date: Jun. 19, 2003

(54) Sending information using an in-progress transaction

(76) Inventor: Jeanine Picraux, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/029,733

(22) Filed: Dec. 18, 2001

(51) Int. Cl. G06F 15/16

(52) U.S. Cl. 709/231

(57) ABSTRACT

The present invention, in various embodiments, provides techniques for using an in-progress data transaction to send additional information. In one illustrative embodiment, two asynchronous nodes are sending data to each other. In one transaction involving the first node sending data to the second node, the second node while receiving part of the data recognizes that the rest of the data being sent is invalid, e.g., due to various kinds of errors. The second node then immediately requests the first node to resend the to-be-received, now erroneous, data. In one embodiment, the second node inserts the request in a data stream being in transit from the second node to the first node. The second node does not need to wait until the boundary of a data transaction, and, in one embodiment, the request is embedded in a “drop packet.”

### FIELD OF THE INVENTION

The present invention relates generally to transmitting data and, more specifically, to sending information using an in-progress data transaction.

### BACKGROUND OF THE INVENTION

Data are often transmitted between different nodes, such as computer systems, network devices, microprocessors, semiconductor chips, electronic chips, etc. In various approaches, data are transmitted at the boundary, but not in the middle, of data transactions. As a result, when a transaction is in progress, if some additional data is to be sent, such as in an interrupt, this additional data must wait until the next boundary of the transaction. In such conditions, mechanisms including state bits, support and control logic, etc., may be required to keep track of transaction boundaries. In retransmits, the existing retransmit algorithm may require modifications to support the interrupting streams. Consequently, complexities and other problems are added to the systems. In asynchronous systems, it is more difficult to locate the transaction boundaries.

Based on the foregoing, it is clearly desirable that mechanisms be provided to solve the above deficiencies and associated problems.

### SUMMARY OF THE INVENTION

The present invention, in various embodiments, provides techniques for using an in-progress data transaction to send additional information. In one illustrative embodiment, two asynchronous nodes are sending data to each other. In one transaction involving the first node sending data to the second node, the second node while receiving part of the data recognizes that the rest of the data being sent is invalid, e.g., due to various kinds of errors. The second node then immediately requests the first node to resend the to-be-received, now erroneous, data. In one embodiment, the second node inserts the request in a data stream being in transit from the second node to the first node. The second node does not need to wait until the boundary of a data transaction, and, in one embodiment, the request is embedded in a “drop packet.”

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows a system upon which embodiments of the invention may be implemented;

FIG. 2 is a flowchart illustrating a method in accordance with one embodiment;

FIG. 3 shows a computer system upon which embodiments of the invention may be implemented.

### DETAILED DESCRIPTION OF THE PREFERRED EMBODIMENT

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

### HARDWARE OVERVIEW

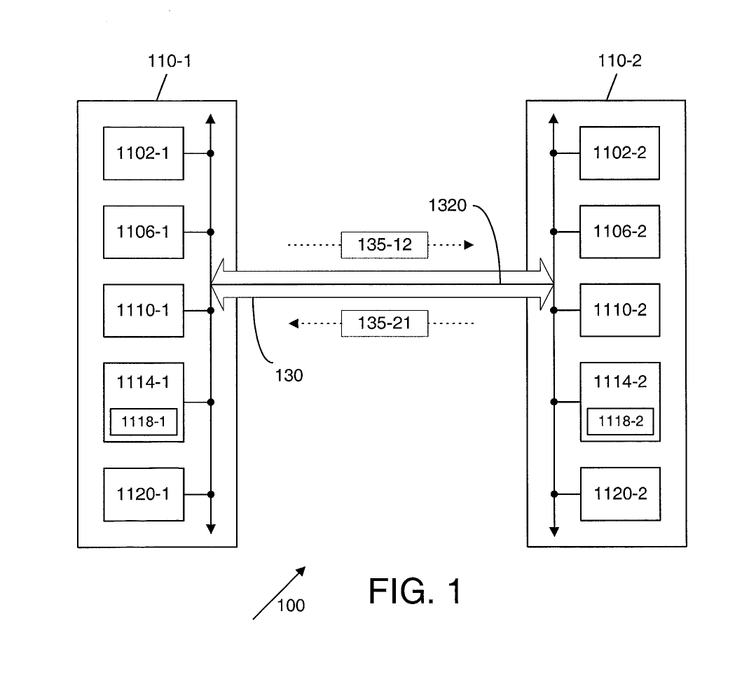

FIG. 1 shows a system 100 upon which embodiments of the invention may be implemented. System 100 includes two nodes 110-1 and 110-2, and a communication link 130. In one embodiment, nodes 110 are asynchronous, i.e., they run on different clocks, at different frequencies, etc., and these frequencies can change relative to one another. Further, a node 110 includes a sending machine 1102, a receiving machine 1106, a queue 1110, a drop packet machine 1114, and a control machine 1120. For illustrative purposes, an element of a node 110 having a name with -1 is associated with node 110-1 while an element having a name with -2 is associated with node 110-2. A node 110 normally keeps track of the status of its elements, the status and position of streams 135 being sent by that same node 110. The term “node” in this document is used for illustrative purpose only, a node 110 may be a communication entity such as a processor, a computer system, a network device, an Application Specific Integrated Circuit (ASIC) device, a programmable logic device (PLD) and their equivalences, etc. Nodes 110 are described as the same, but they can be different and/or have different functionalities.

A sending machine 1102 sends data while a receiving machine 1106 receives data. Queue 1110 queues data to be transmitted. Data in queue 1110 is normally selected through an arbitration process and is commonly referred to as arbitration winners, which are to be sent by sending machine 1102. In one embodiment, the data is in the form of streams or packets 135 each of which comprises a set of information arranged in various parts or pieces that are logically consecutive but are not necessarily physically consecutive. At one time, multiple streams 135 may be in transit between nodes 110, and these streams may be time interleave. That is, not all parts of a stream are consecutive, but a part may be sandwiched by some parts of one or more other streams. For illustrative purposes, a stream 135 having a name with -12 indicates that the stream is traveling form node 110-1 to node 110-2 while a stream having a name with -21 indicates that the stream is traveling from node 110-2 to node 110-1; the term transaction indicates a distinct stream of data being sent from one node 110 to another node 110; and a transaction starts at the beginning boundary of a stream and ends at the ending boundary of the same stream. In one embodiment, a transaction includes a header embedding information related to the transaction, including clues as to the transaction's size, type, etc. The receiving node 110, via its receiving machine 1106 and based on the header information, counts the number of data pieces received in a transaction and thus determines the ending boundary of the transaction. Normally, when the last data count is received, the transaction ends. As a result, once a transaction starts, transaction data length may not be changed or the data counts may mismatch the information in the header and cause errors in the transaction data. However, a drop packet 1118 is not counted as part of the transaction data even if the packet is sent in the middle of a transaction. A receiving node 110, recognizing a drop packet 1118, discards it in counting the number of data pieces in the transaction. A drop packet 1118 can be sent several times from a sending node 110 to a receiving node 110 so that the receiving node 110 is more likely to receive a valid packet 1118. For example, in an interrupt, a series of four drop packets is sent.

Drop packet machine 1114 provides drop packets 1118 to be used in accordance with the techniques disclosed herein. In one embodiment, a drop packet 1118 includes various bits, one of which, at appropriate time, is used as a marker to identify the drop packet as distinct and separate from a normal data packet. The marker bit is commonly referred to as a drop line. When not used as a drop-packet marker, the marker bit may be used for other purposes. In various situations, such as in an interrupt, a retransmit, etc., drop packet machine 1114 working with control machine 1120 may override the arbitration winner in queue 1110 for a drop packet 1118 to be sent in place of the winner that would otherwise be sent to the receiving node. Consequently, a drop packet 1118 can be forced into a stream 135 and be sent to a receiving node at any time during a transaction even when the transaction has been in progress or the drop packet is not required for frequency or synchronization purposes. As a result, the drop packet 1118 can be sent without having to wait till a boundary of a data transaction, or without regards to the types of transactions, e.g., a retransmit, a regular, an idle stream, etc. When a drop packet 1118 is forced into a stream 135, relevant machines and data streams of both sending and receiving nodes can be halted immediately and the status of system 100 can be saved for later use. System 100's status includes, for example, the arbitration states, the position of each stream 135 in queue 1110 and on communication link 130, whether the interrupted transaction is to be resumed or discarded, etc. Both sending and receiving nodes have the options of discarding the interrupted transaction or, based on the saved states, continuing with the transaction where it was left off.

In one embodiment, a drop packet 1118 includes coded information to be sent between nodes 110 in which the coded information includes instructions for a receiving node 110 to perform some tasks, such as asking the receiving node to resend un-received but erroneous data, to inactivate itself to be replaced by another node, to replace an element of a node, etc. If a drop packet 1118 includes special instructions for a receiving node 110 to perform, then the receiving node, recognizing these instructions, pays attention to them. Otherwise, the receiving node 110 and the drop packet 1118 function as usual. Drop packets 1118 may also be used to synchronize or match frequencies of nodes 110. For example, transmitting data from node 110-1 to node 110-2 may desire twelve pieces of data while only eight pieces of data are to be used by the receiving node 110-2, at least four drop packets 1118 would be sent with the eight pieces to constitute the twelve desired pieces. The four or more drop packets 1118, when received by node 110-2, are disregarded or “dropped.”

Control machine 1120 makes decisions and performs various tasks for node 110, such as to perform an interrupt, to arbitrate data pieces to be sent, to override a transaction, to resume an interrupted transaction, to save the system status, to coordinate handshakes, etc. Control machine 1120 can indefinitely stall sending and receiving mechanisms of a node 110 and, if desired, resume those mechanisms. Control machine 1120 can also manipulate the drop packet transaction in a transparent way to the synchronization mechanism but useful to nodes 110.

Communication link 130 transports data between appropriate elements at its two ends, and thus varies to appropriately accommodate those elements. Examples of communication link 130 include network media, interconnection fabrics, rings, crossbars, etc. In one embodiment, communication link 130 includes a plurality of channels that carry data, and once a channel is used for a transaction, all data pieces for that transaction are transmitted on that same channel. Further, one of the channels, e.g., channel 1320, serves as a channel override to be used by drop packets 1118, e.g., when these packets override usual data streams. Data in a channel override has higher priority to be sent than data in other channels.

### METHOD STEPS IN ACCORDANCE WITH ONE EMBODIMENT

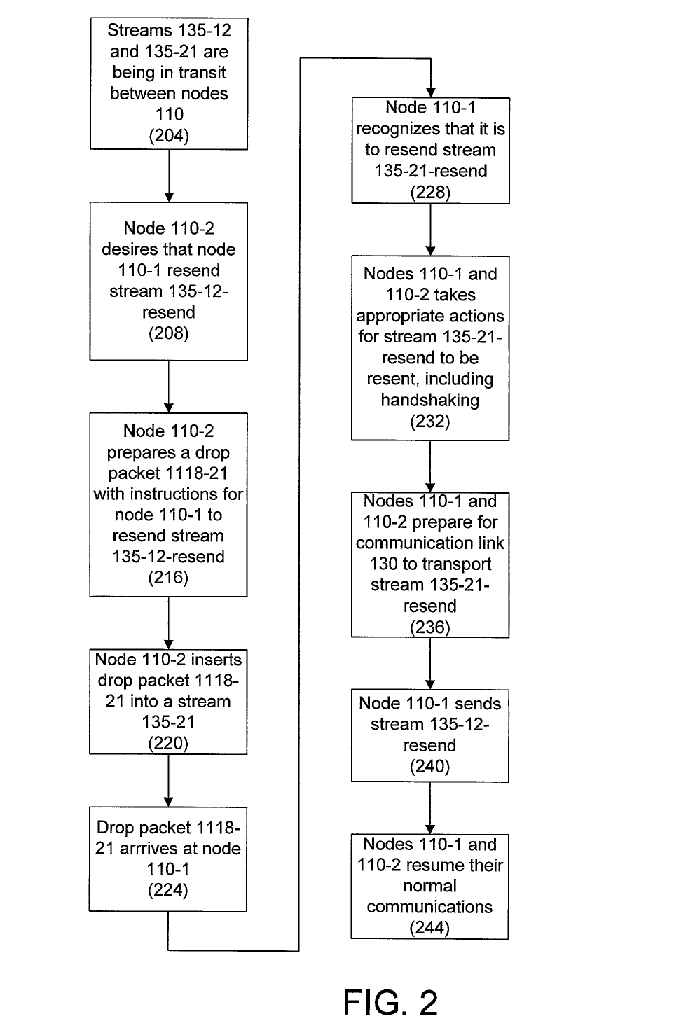

FIG. 2 is a flowchart illustrating the method steps in accordance with one embodiment. In step 204, a stream 135-12 and a stream 135-21 are being in transit to node 110-2 and node 110-1, respectively.

In step 208, while receiving some part of stream 135-12 node 110-2 recognizes that it does not want to continue receiving the rest of stream 135-12, e.g., due to some system or protocol errors. Node 110-2 instead desires that node 110-1 resends the parts of stream 135-12 that have not been received by node 110-2. For illustration purposes, these parts are referred to as a stream 135-12-resend.

In step 216, node 110-2 requests that drop packet machine 1114-2 prepare a drop packet 1118-21 that includes instructions for node 110-1 to resend stream 135-12-resend. Drop packet 1118-21 also includes information for node 110-1 to recognize that this drop packet 1118-21 is not a normal drop packet, but, instead, a drop packet having instructions for receiving node 110-1.

In step 220, node 110-2 inserts drop packet 1118-21 in stream 135-21 without having to wait till the end of stream 135-21 transaction. For example, stream 135-21 includes ten data pieces, and three data pieces have been sent to node 110-1. Drop packet machine 114-2, in coordination with sending machine 1112-2 and/or control machine 1120-2 arranges for drop packet 1118-21 to be sent in place of the fourth data piece that would have been sent if the drop packet 1118-21 were not to be sent.

Instep 224, drop packet 1118-21 arrives at node 110-1. Instep 228, node 110-1, based on information in drop packet 118-21, recognizes that node 110-1 should follow instructions embedded in drop packet 1118-21, that is, to resend stream 135-12-resend to node 110-2.

In step 232, each node 110-1 and 110-2 takes appropriate actions so that stream 135-12-resend can be resent. For example, each node 110-1 and 110-2 stalls its corresponding queue 1110 and other machines under its controls, stores the status of the queues and those machines so that, if desired, the transaction of stream 135-21 may resume after the resend is complete.

Each node 110-1 and node 110-2 also handshakes before the resend starts. In one embodiment, when a node 110 is ready to receive or to send additional data, that node 110 sends a message to the other node to so inform. The other node, when receiving the message, sends a receipt acknowledgement. For example, if node 110-1 is ready to receive data from node 110-2, node 110-1 sends a message to node 110-2 to let node 110-2 know that node 110-1 is ready to receive data. In return, node 110-2 sends a message to node 110-1 acknowledging that node 110-2 recognizes that node 110-1 is ready, node 110-2 then sends data to node 110-1 as appropriate. Similarly, if node 110-1 is ready to send data to node 110-2, node 110-1 sends a message to node 110-2 to let node 110-2 know that node 110-1 is ready to send data. In return, node 110-2 sends a message to node 110-1 acknowledging that node 110-2 recognizes that node 110-1 is ready, etc.

In step 236, node 110-1 and node 110-2 prepare for communication link 130 to transport stream 135-12-resend. In one embodiment, node 110-1 and node 110-2 perform a link-initiation on communication link 130. In step 240, node 110-1 sends stream 135-12-resend to node 110-2. In step 244, node 110-1 and node 110-2 restore their corresponding status before the resend so that they can resume their normal communications.

### VARIOUS APPLICATIONS

In the above example, only one stream 135 in transit between one node 110 to another node 110 is used for illustration purposes. However, techniques of the invention are not limited to that situation, but are applicable in other situations including multiple streams. For example, at one time, multiple streams, e.g., streams 135A-12, 135B-12, and 135C-12, etc. (not shown), are in transit from node 110-1 to node 110-2, and similarly, multiple streams, e.g., streams 135A-21, 135B-21, and 135C-21, etc. (not shown), are in transit from node 110-2 to node 110-1. When node 110-2 desires to insert a drop packet 1118-21 into a stream 135-21, node 110-2 can conveniently select any one of the packets 135A-21, 135B-21, 135B-21, etc. Further, each stream 135-21 can be of different types, sizes, or lengths, and stream 135A-21 may be on a channel different from that of stream 135B-21.

Additionally, the above example is in the context of a resend (or retransmit) of erroneous data. However, techniques of the invention may be used in different contexts such as when a stream 135 is interrupted for it to carry additional information, including, for example, restarts, resets, notifications, authorizations, add and/or delete elements online, etc. For example, a part or a whole of node 110-1 may be substituted by another part or node. A node may be deleted from system 100. Node 110-2 can insert instructions into drop packet 1118-21 to instruct node 110-1 to shut down, remove some of its components, or completely remove itself from system 100. Such applications can be used in microprocessors and/or other applications in coherency signaling, cache line, etc.

### COMPUTER SYSTEM OVERVIEW

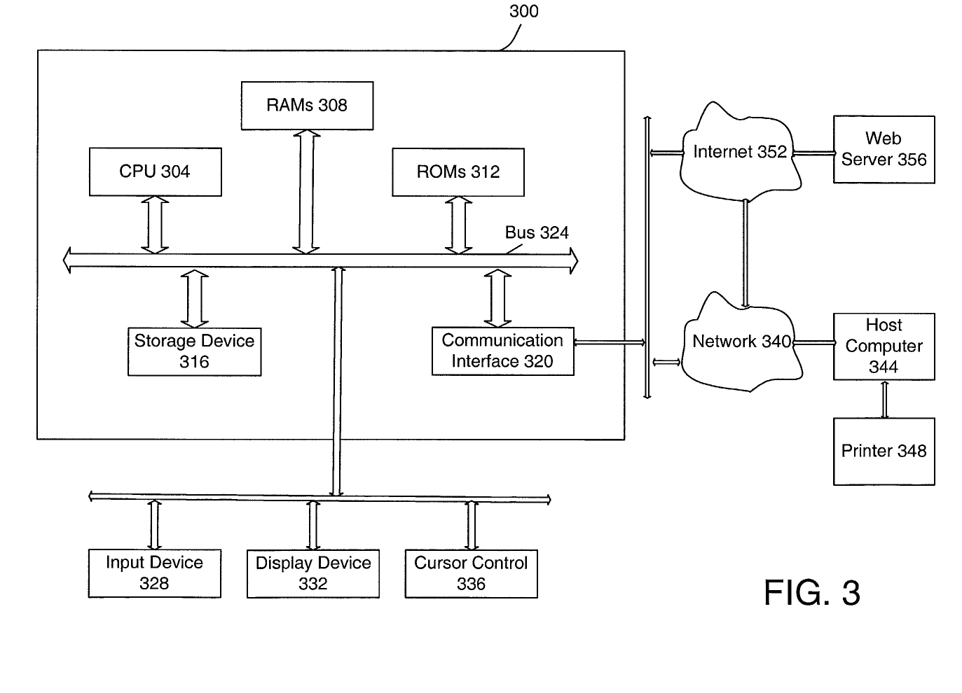

FIG. 3 is a block diagram showing a computer system 300 upon which an embodiment of the invention may be implemented. For example, computer system 300 may be implemented to include system 100, to serve as a node 110, to perform functions in accordance with the techniques described above, etc. In one embodiment, computer system 300 includes a processor 304, random access memories (RAMs) 308, read-only memories (ROMs) 312, a storage device 316, and a communication interface 320, all of which are connected to a bus 324.

Processor 304 controls logic, processes information, and coordinates activities within computer system 300. In one embodiment, processor 304 executes instructions stored in RAMs 308 and ROMs 312, by, for example, coordinating the movement of data from input device 328 to display device 332.

RAMs 308, usually being referred to as main memory, temporarily store information and instructions to be executed by processor 304. Information in RAMs 308 may be obtained from input device 328 or generated by processor 304 as part of the algorithmic processes required by the instructions that are executed by processor 304.

ROMs 312 store information and instructions that, once written in a ROM chip, are read-only and are not modified or removed. In one embodiment, ROMs 312 store commands for configurations and initial operations of computer system 300.

Storage device 316, such as floppy disks, disk drives, or tape drives, durably stores information for used by computer system 300.

Communication interface 320 enables computer system 300 to interface with other computers or devices. Communication interface 320 may be, for example, a modem, an integrated services digital network (ISDN) card, a local area network (LAN) port, etc. Those skilled in the art will recognize that modems or ISDN cards provide data communications via telephone lines while a LAN port provides data communications via a LAN. Communication interface 320 may also allow wireless communications.

Bus 324 can be any communication mechanism for communicating information for use by computer system 300. In the example of FIG. 3, bus 324 is a media for transferring data between processor 304, RAMs 308, ROMs 312, storage device 316, communication interface 320, etc.

Computer system 300 is typically coupled to an input device 328, a display device 332, and a cursor control 336. Input device 328, such as a keyboard including alphanumeric and other keys, communicates information and commands to processor 304. Display device 332, such as a cathode ray tube (CRT), displays information to users of computer system 300. Cursor control 336, such as a mouse, a trackball, or cursor direction keys, communicates direction information and commands to processor 304 and controls cursor movement on display device 332.

Computer system 300 may communicate with other computers or devices through one or more networks. For example, computer system 300, using communication interface 320, communicates through a network 340 to another computer 344 connected to a printer 348, or through the world wide web 352 to a server 356. The world wide web 352 is commonly referred to as the “Internet.” Alternatively, computer system 300 may access the Internet 352 via network 340.

Computer system 300 may be used to implement the techniques described above. In various embodiments, processor 304 performs the steps of the techniques by executing instructions brought to RAMs 308. In alternative embodiments, hard-wired circuitry may be used in place of or in combination with software instructions to implement the described techniques. Consequently, embodiments of the invention are not limited to any one or a combination of software, hardware, or circuitry.

Instructions executed by processor 304 may be stored in and carried through one or more computer-readable media, which refer to any medium from which a computer reads information. Computer-readable media may be, for example, a floppy disk, a hard disk, a zip-drive cartridge, a magnetic tape, or any other magnetic medium, a CD-ROM, a CD-RAM, a DVD-ROM, a DVD-RAM, or any other optical medium, paper-tape, punch-cards, or any other physical medium having patterns of holes, a RAM, a ROM, an EPROM, or any other memory chip or cartridge. Computer-readable media may also be coaxial cables, copper wire, fiber optics, acoustic, or light waves, etc. As an example, the instructions to be executed by processor 304 are in the form of one or more software programs and are initially stored in a CD-ROM being interfaced with computer system 300 via bus 324. Computer system 300 loads these instructions in RAMs 308, executes some instructions, and sends some instructions via communication interface 320, a modem, and a telephone line to a network, e.g. network 340, the Internet 352, etc. A remote computer, receiving data through a network cable, executes the received instructions and sends the data to computer system 300 to be stored in storage device 316.

In the foregoing specification, the invention has been described with reference to specific embodiments thereof. However, it will be evident that various modifications and changes may be made thereto without departing from the broader spirit and scope of the invention. Techniques of the invention may be implemented as a system, a device, an apparatus or their equivalences, a method or a process, a computer-readable medium, etc. Accordingly, the specification and drawings are to be regarded as illustrative rather than as restrictive.

What is claimed is:

1. A method for transmitting information from a second node to a first node, comprising the steps of:
establishing a communication link between the first node and the second node;
allowing one or more data transactions transmitted on the communication link between the first node and the second node;
identifying a data stream of a data transaction being transmitted from the second node to the first node; and
stalling the transaction to insert the information into the data stream, thereby transmitting the information from the second node via the data stream to the first node;
wherein the information is not part of the data transaction when the data transaction starts from the second node to the first node.

2. The method of claim 1 further comprising the step of running the first node and the second node at two different frequencies.

3. The method of claim 1 further comprising the step of including instructions in the information for the first node to perform a task.

4. The method of claim 3 wherein the task includes one or a combination of resending some data, removing the first node, removing a part of the first node, restarting the first node, resetting the first node, notifying the first node, authorizing the first node.

5. The method of claim 1 further comprising the step of sending the information in a packet normally used for synchronizing the first node and the second node.

6. The method of claim 1 further comprising the step of sending the information in a packet that is not counted as part of the data stream being transmitted from the second node to the first node.

7. The method of claim 1 wherein the first node and the second node are selected from a group consisting of a computer system, a network device, a microprocessor, and an electronic chip.

8. The method of claim 1 further comprising the steps of saving the status of the transaction at the time the transaction is stalled and resuming the transaction based on the saved status.

9. A method for transmitting information from a second node to a first node, comprising the steps of:
establishing a communication link between the first node and the second node;
identifying a data transaction being transmitted from the second node via the data link to the first node; the data transaction including a header and a plurality of data pieces;
the first node, based on data in the header, counting the data pieces to identify the end of the transaction;
stalling the data transaction to send a packet on the communication link to the first node; the packet including the information; and
the first node counting the packet as not part of the data transaction.

10. The method of claim 9 further comprises the step of running the first node and the second node at two different frequencies.

11. The method of claim 9 further comprises the step of including instructions in the information for the first node to perform a task.

12. A system for transmitting information from a second node to a first node, comprising:
a communication link between the first node and the second node;
one or more data transactions transmitted on the communication link between the first node and the second node;
a data stream of a data transaction being transmitted from the second node to the first node; and
means for stalling the transaction to insert the information into the data stream, thereby transmitting the information from the second node via the data stream to the first node;
wherein the information is not part of the data transaction when the data transaction starts from the second node to the first node.

13. The system of claim 12 wherein the first node and the second node run at two different frequencies.

14. The system of claim 12 wherein the information includes instructions for the first node to perform a task.

15. The system of claim 14 wherein the task includes one or a combination of resending some data, removing the first node, removing a part of the first node, restarting the first node, resetting the first node, notifying the first node, authorizing the first node.

16. The system of claim 12 wherein the information is sent in a packet normally used for synchronizing the first node and the second node.

17. The system of claim 12 wherein the information is sent in a packet that is not counted as part of the data stream being transmitted from the second node to the first node.

18. The system of claim 12 wherein the first node and the second node are selected from a group consisting of a computer system, a network device, a microprocessor, and an electronic chip.

19. The system of claim 12 wherein the status of the transaction is saved at the time the transaction is stalled and the transaction is resumed based on the saved status.

20. A system for transmitting information from a second node to a first node, comprising:
a communication link between the first node and the second node;
a data transaction being transmitted from the second node via the communication link to the first node; the data transaction including a header and a plurality of data pieces;
means for the first node, based on data in the header, to count the data pieces to identify the end of the transaction;
means for stalling the data transaction to send a packet on the communication link to the first node; the packet including the information; and
means for the first node to count the packet as not part of the data transaction.

21. The system of claim 20 wherein the first node and the second node run at two different frequencies.

22. The system of claim 20 wherein the information includes instructions for the first node to perform a task.

23. A computer-readable medium embodying instructions for a computer to perform a method for transmitting information from a second node to a first node, the method comprising the steps of:
establishing a communication link between the first node and the second node;
allowing one or more data transactions transmitted on the communication link between the first node and the second node;
identifying a data stream of a data transaction being transmitted from the second node to the first node; and
stalling the transaction to insert the information into the data stream, thereby transmitting the information from the second node via the data stream to the first node;
wherein the information is not part of the data transaction when the data transaction starts from the second node to the first node.

24. A computer-readable medium embodying instructions for a computer to perform a method for transmitting information from a second node to a first node, the method comprising the steps of:
establishing a communication link between the first node and the second node;
identifying a data transaction being transmitted from the second node via the data link to the first node; the data transaction including a header and a plurality of data pieces;
the first node, based on data in the header, counting the data pieces to identify the end of the transaction;
stalling the data transaction to send a packet on the communication link to the first node; the packet including the information; and
the first node counting the packet as not part of the data transaction.
